(19) United States
(12) Patent Application Publication
(10) Pub. No.: US 2026/0366897 A1
(43) Pub. Date: Nov. 19, 2026

(54) SIGNAL POWER MEASUREMENT FOR HIGH PROCESS NOISE DETECTION IN MAGNETIC FLOW METERS

(71) Applicant: Micro Motion, Inc., Boulder, CO (US)

(72) Inventors: Brendan Robert McLaughlin, Orono, MN (US); Scot Ronald Foss, Eden Priarie, MN (US)

(21) Appl. No.: 19/641,895

(22) Filed: Apr. 8, 2026

Related U.S. Application Data
(60) Provisional application No. 63/804,984, filed on May 13, 2025.

(51) Int. Cl. G01F 1/60; G01F 1/58

(52) U.S. Cl. CPC G01F 1/60; G01F 1/588

(57) ABSTRACT

A magnetic flow meter for sensing a flow rate of a fluid flow includes a flow tube assembly including a pipe section which receives the fluid flow. A coil is receives a coil current and produce a magnetic field across the fluid flow that induces an electromotive force (EMF) in the fluid flow proportional to the flow rate. Electrode sensors sense the EMF and generate electrode voltage values that provide a sensor signal that is indicative of the flow rate. Measurement circuitry samples a waveform of the magnetic field using the electrode voltage values. A noise diagnostic module performs a diagnostic and parses first and second time periods of the waveform, the first time period includes noise in the sensor signal and the second time period is indicative of a settled portion of the sensor signal.

### CROSS-REFERENCE TO RELATED APPLICATION

The present application is based on and claims the benefit of U.S. provisional patent application Ser. No. 63/804,984, filed May 13, 2025, the content of which is hereby incorporated by reference in its entirety.

### BACKGROUND

Magnetic flowmeters (or mag meters) measure flow by application of Faraday's Law, an electromagnetic effect. The magnetic flowmeter energizes one or more coils by passing an excitation current through field windings which generates a magnetic field across an electrically isolated, conductive process flow. An electromotive force (EMF) is generated by the flowing process fluid crossing through the magnetic field; this induced voltage (potential) both across the fluid and with respect to the rest of the process fluid can readily be measured by one or more conductive electrodes that contact the flowing process fluid. Alternatively, some magnetic flowmeters employ capacitive coupling between the electrodes and the process fluids such that the potential can be measured without direct electrical connection to the process. The volumetric flow is proportional to the flow velocity and the cross-sectional area of the flowtube. As the flow velocity is directly proportional to the electrode voltage potential (EV), the electrode voltage potential (EV) is directly proportional to the induced magnetic field strength (B), and the induced magnetic field strength is assumed to be proportional to the applied magnetic field (H), which is directly linked to the magnitude of the excitation current, a direct correlation is provided between measured electrode voltage potential and indicated volumetric flow.

Magnetic flowmeters are useful in a variety of conductive and semi-conductive fluid flow measurement environments. In particular, the flow of water-based fluids, ionic solutions and other conducting fluids can all be measured using magnetic flowmeters. Thus, magnetic flowmeters can be found in water treatment facilities, beverage and hygienic food production, chemical processing, high purity pharmaceutical manufacturing, as well as hazardous and corrosive processing facilities. Magnetic flowmeters are often employed in the hydrocarbon fuel industry which sometimes employs hydraulic fracturing techniques using abrasive and corrosive slurries.

The sensitivity of the flowmeter can be increased, and the impact of noise on measured flow rate reduced, by increasing the electrical potential that is generated due to flow. One technique to increase this potential is to apply a larger magnetic field by supplying a larger current to the electric coils. However, in many installations there is a limit to available power and thus a limit to the amount of current that can be supplied to the coils of the magnetic flowmeter. Because the amplitude of the sensed potential is limited, noise present in the sensed potential can impact diagnostics and performance of the flowmeter.

### SUMMARY

A magnetic flow meter for sensing a flow rate of a fluid flow includes a flow tube assembly including a pipe section configured to receive the fluid flow. A coil is configured to receive a coil drive signal and produce a magnetic field across the fluid flow that induces an electromotive force (EMF) in the fluid flow that is proportional to the flow rate. Electrode sensors are arranged to sense the EMF and generate electrode voltage values that provide a sensor signal that is indicative of the flow rate. Measurement circuitry is configured to sample a waveform of the magnetic field using the electrode voltage values of the sensor signal. A noise diagnostic module is configured to perform a diagnostic and parse a first time period of the wave form and a second time period of the waveform, wherein the first time period includes noise in the sensor signal and the second time period is indicative of a settled portion of the sensor signal.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

FIG. 1 is a diagrammatic view showing a process control system including a magnetic flowmeter.

FIG. 2 is a block diagram of a magnetic flowmeter with which embodiments of the present invention are particularly applicable.

FIG. 3A is a comparison graph of ideal electrode readings versus noisy electrode readings of a magnetic flowmeter.

FIG. 3B is a detailed graph of the noisy electrode readings of a magnetic flowmeter of FIG. 3A.

FIG. 4 is a comparison graph of ideal SNR readings versus legacy SNR readings when process noise is injected when performing diagnostics.

FIG. 5 is a flow diagram of the signal power calculation process in a particular embodiment of a magnetic flowmeter.

### DETAILED DESCRIPTION OF ILLUSTRATIVE EMBODIMENTS

Embodiments of the present disclosure are described more fully hereinafter with reference to the accompanying drawings. Elements that are identified using the same or similar reference characters refer to the same or similar elements. Some elements may not be shown in each of the figures in order to simplify the illustrations.

The various embodiments of the present disclosure may be embodied in many different forms and should not be construed as limited to the specific embodiments set forth herein. Rather, these embodiments are provided so that this disclosure will be thorough and complete, and will fully convey the scope of the present disclosure to those skilled in the art.

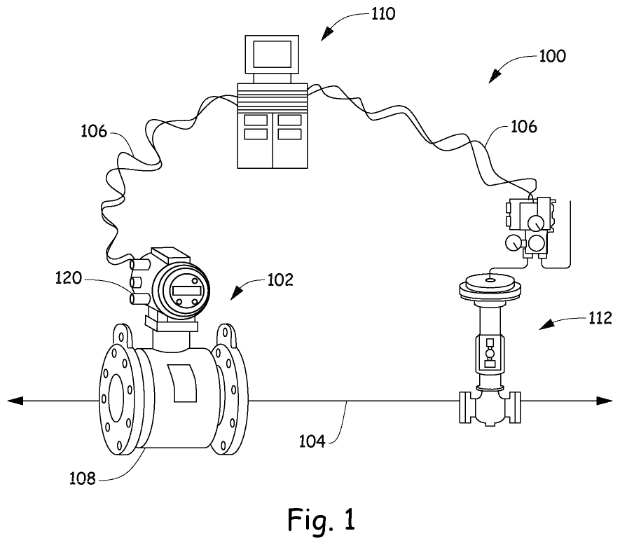

FIG. 1 illustrates a typical environment 100 for magnetic flowmeter 102. Magnetic flowmeter 102 is coupled to process piping, illustrated diagrammatically at line 104 that also couples to control valve 112. Magnetic flowmeter 102 is configured to provide a flow rate output relative to process fluid flow through piping 104 in a process. Examples of such process fluids includes slurries and liquids in chemical, pulp, pharmaceutical and other fluid processing plants.

Magnetic flowmeter 102 includes electronics housing 120 connected to flowtube 108. Magnetic flowmeter 102 outputs are configured for transmission over long distances to a controller or indicator via process communication connection 106. In typical processing plants, communication connection 106 can be either a digital communication protocol, or an analog communication signal. The same or additional process information can be made available via wireless communication, pulse width or frequency output, or discrete input/outputs (DI/DO). System controller 110 can display flow information for a human operator as well as provide control signals over process communication connection 106 in order to control the process using control valves, such as valve 112.

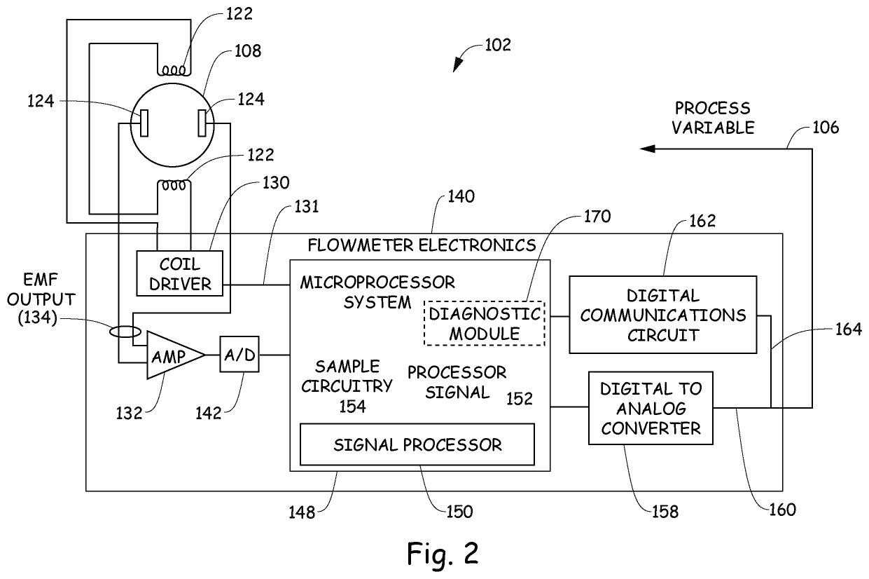

FIG. 2 is a block diagram of a magnetic flowmeter with which embodiments of the present invention are particularly applicable. Magnetic flowmeter 102 measures a flow of conductive process fluid through flowtube assembly 108. Coils 122 are configured to apply an external magnetic field in the fluid flow in response to an applied excitation current, a coil drive signal, from coil driver 130. EMF sensors (electrodes) 124 electrically couple to the fluid flow and provide an EMF signal output 134 to amplifier 132 related to an EMF generated in the fluid flow due to the applied magnetic field, fluid velocity, and noise. Analog-to-digital converter (ADC or A/D) 142 provides a digitized EMF signal to microprocessor system 148. A signal processor 150 is implemented in microprocessor system 148 of flowmeter electronics 140 which couples to the EMF output 134 to provide an output 152 related to fluid velocity.

Microprocessor system 148 calculates fluid flow velocity through flowtube 108 in accordance with a relationship between the EMF output 134 and flow velocity as described in an application of Faraday's Law:

$$V = \frac{E}{kBD}$$

Where E can be the signal output 152 which is related to the EMF output 134, V is the velocity of the fluid, D is the diameter of the flowtube 108, B is the strength of the induced magnetic field in the fluid, and k is a constant of proportionality. A nuance of this application of Faraday's law is that the excitation current, I, is considered directly proportional to B, the induced magnetic field. Coil driver 130 provides both the excitation current and a measurement of either the induced magnetic field or excitation current, which is important for the accuracy of the velocity measurement. The measurement of the excitation current is provided through line 131. Microprocessor system 148 uses velocity and measured magnetic field or coil current to calculate flow of the process fluid in accordance with known techniques. A digital-to-analog converter 158 coupled to microprocessor system 148 and generates an analog transmitter output 160 for coupling to communication bus 106. A digital communication circuit 162 generates a digital transmitter output 164. The analog output 160 and/or the digital output 164 can be coupled to process controllers or monitors as desired.

It is desirable to provide high performance flow measurements at many locations throughout an industrial process plant, including hazardous areas. This requires a high performance design while within the power constraints of a typical industry standard configuration. Magnetic flowmeters are driven (excited) through coils 122 at a certain power to produce a viable flow signal at low coil drive frequencies. Magnetic flowmeters thus need a satisfactory coil drive frequency that can be achieved with a relatively low drive current. However, process noise present in the potential sensed by the electrodes 124 can cause noisy electrical readings and potential variations in flow rate measurements. This process noise can include electrical noise near the electrode sensors caused by the fluid flow and spike noise caused by particle collision with the electrode sensors.

Referring to FIG. 2, in a particular embodiment, microprocessor 148 further includes a noise diagnostic module 170. With the present invention, a noise diagnostic module 170 for a magnetic flowmeter is provided that improves signal power measuring, provides real time process noise values, and improves the process noise signal-to-noise ratio (SNR) by guiding users to pick the best coil drive frequency.

This configuration provides a way for the flowmeter to detect if there is process noise present in the potential sensed by the electrodes, which causes the noisy electrical readings and potential variations in flow rate measurements. This diagnostic information can be used to detect situations in which the process fluid causes electrical noise around the electrodes. These diagnostic readings also can detect spike noise, which can be caused when particles collide with the electrode. In one configuration, the diagnostics module 170 uses these electrode measurements and calculates the signal-to-noise ratios (SNRs) for the low and high frequency excitation of the flowmeter coils. In one embodiment, if one of the SNRs crosses a threshold, then the flowmeter will activate an alert. Once a user is notified of the alert, they will be able to view the SNRs of both coil drive frequencies. Based on the SNRs, the user can then decide which coil drive frequency will provide better performance.

In another aspect, the signal power measurement can be used as a secondary flow reference value to further diagnose issues with the flow value. In legacy systems, previous signal power measurements have been affected by external noise and cannot be used as a confident flow rate reference. The formula for SNRs can be seen in Equation 1.

$$SNR = \frac{S ignal Power Magnitude}{Noise Magnitude} . \qquad Equation 1$$

The SNR is calculated from the signal power magnitude divided by the noise magnitude. The signal power magnitude may be extracted from the signal using a frequency analysis and the noise magnitude is measured at frequencies adjacent to the coil drive frequencies. In some existing magnetic flowmeters, the signal power magnitude measurement calculation is performed in a way that includes every sample from the electrodes. This can lead to invalid and inconsistent signal power measurements due to the coil switching transient caused by the changing coil current. Additionally, diagnostic signals present on the sense electrodes can also cause inconsistent signal power measurements.

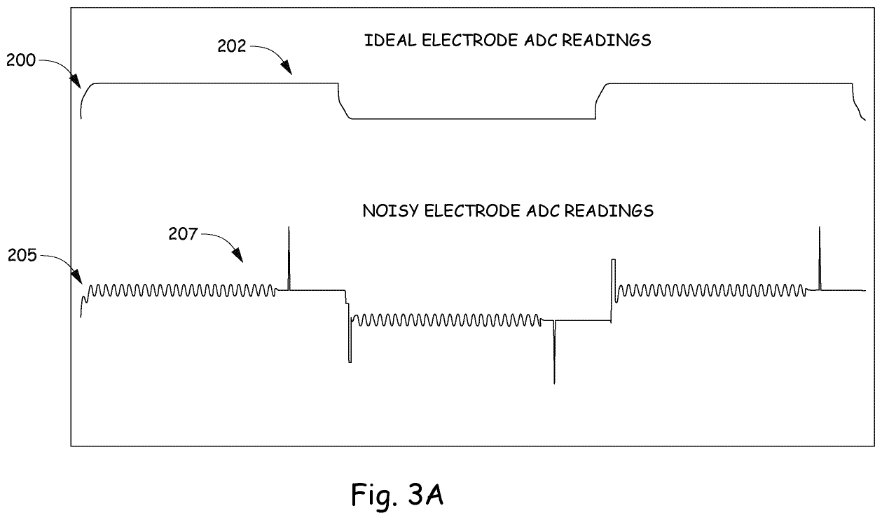

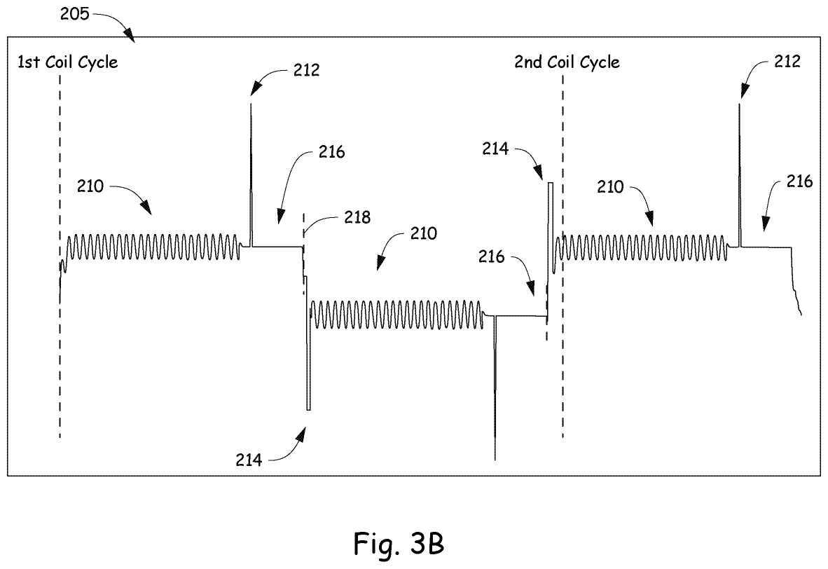

FIG. 3A is a comparison of the ideal electrode ADC readings of a flowmeter versus noisy electrode ADC readings. FIG. 3A illustrates the ideal electrode readings in graph 200 as line 202 and the noisy electrode readings in graph 205 as line 207. The distortions due to the noise as illustrated in line 207 are due to the coil switching transients and injected diagnostic signals superimposed on the measurement signal.

FIG. 3B illustrates the noisy electrode readings 205 as shown in FIG. 3A when noise is present in greater detail. The injected noise 210 in the measured ADC readings is from an electrode impedance measurement, which superimposes a sine wave used to calculate impedance and causes distortion in the wave. The large spike 212 at the end of the ‘injected wave’ section 210 is from the flowmeter's internal flow simulator (IFS) diagnostic. The IFS diagnostics injects a signal directly onto the input of the analog to digital convertor and is used to test front end electronics. The IFS diagnostic may be located within the microprocessor system 148 or within the flowmeter electronics 140. It should be noted that although the Figures and description refer to injected diagnostic signals, such as the noise in injected signal 210, this is exemplary only, and not all magnetic flow meters inject diagnostic signals as discussed herein. The present invention is not limited to removing noise caused by injected diagnostic signals. The use of the IFS is exemplary only, and embodiments of the present invention may improve SNRs by rejecting the coil switching transients and other noise present within the signal.

FIG. 3B further illustrates the reversal of the magnetic field every half wave of the applied coil drive signal at the dashed line 218. Another noise component illustrated in FIG. 3B is the spikes caused by the coil switching transient 214 caused by the reversal of the magnetic field every half wave of the applied coil drive signal. The waveform signal section 216 comprises the settled portion of the last part of each half wave that is untouched by noise. In this example, the settled portion 216 comprises the portion of the signal between spike 212 of the injected noise and spike 214 of the coil switching transient. In this illustrated example, the settled portion comprises approximately the last 20% of each half wave. This settled portion 216 of the waveform is noise-free and can be used for improved flow calculations as it is left untouched by the coil switching transients 214, injected noise 212, and other noise present in the signal.

The measurement circuitry is configured to sample the waveform of the electrode voltage such that the sensor signal has a first time period and a second time period. The first time period is indicative of the sensor signal during which noise is present and the second time period is indicated by the settled portion 216 during which the sensor signal is noise-free. As discussed above, the noise includes the large spike 212 at the end of the ‘injected wave’ section 210 as well as the coil switching transient spikes 214.

The noise diagnostic module 170 is configured to measure the flow signal magnitude using samples from the second time period that ignore parasitic signals such as coil switching transients or injected diagnostic signals. The noise magnitude is measured at frequencies adjacent to the coil drive frequencies. The signal power diagnostic parses the sensor signal for the second time period for the settled portion time window after the coil switching transients and diagnostic signal have decayed. The noise diagnostic module 170 is further configured to calculate the signal to noise ratios of the flow signal using the settled portion during the second time period.

In legacy systems, the coil switching transients and injected noise in the signal can deviate the process noise diagnostic values by up to 30%, and this variation in signal power has the potential of causing a false positive in the SNR reading. This false positive can lead to an undiagnosed high process noise fault.

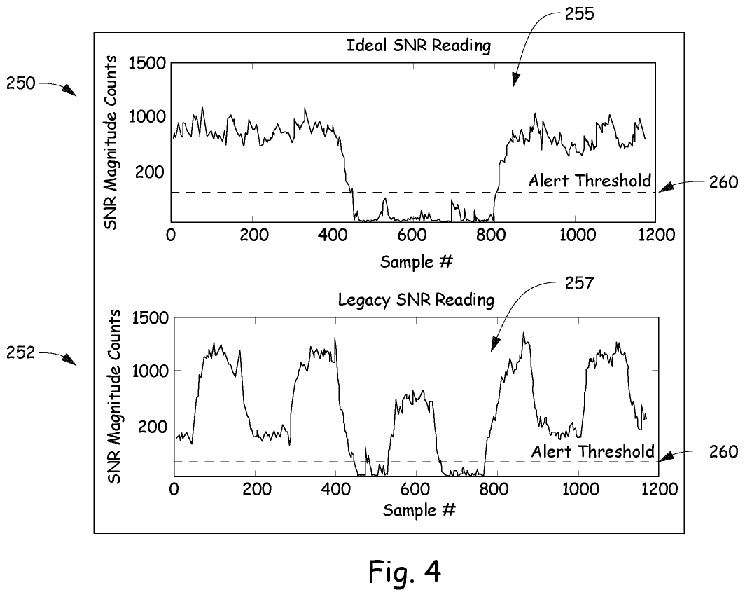

FIG. 4 compares the graphs of an ideal SNR reading 250 versus the SNR reading of a legacy system 252 in a scenario when noise is included in the SNR calculations. The graphs 250, 252 show the change in signal magnitude counts taken over a period of samples to illustrate low frequency SNRs as the transmitter detects simulated high process noise injections. The simulated noise injection is present for the samples contained in the windows 255, 257 during the sample count 400 to 800 on graphs 250, 252 respectively. As can be seen, the ideal design configuration of graph 250 stays under the alert threshold 260 for the entirety of the process noise injection. During this time, a user can be accurately notified of a high process noise alert. In the bottom graph 252, the typical existing SNRs rise above the alert threshold 260 for the majority of the high process noise injection. Because of this, a user would only briefly see a high process noise alert. Furthermore, depending on their alert trigger time, the alert may never trigger even when high process noise is present. This failure could cause a transmitter to provide inaccurate measurements while the diagnostics fail to show any faults.

In an embodiment of the present invention, the diagnostics do not include coil switching transients or the injected noise in its analysis, such as shown in FIG. 3B. Instead, the diagnostics module 170 utilizes the settled portion 216 of the waveform that are not affected by noise. This design provides the user with a highly accurate signal power measurement, which can be used in the calculation of the SNRs. This signal power measurement may be further converted to feet per second, which allows it to be compared to the flow rate of the fluid flow.

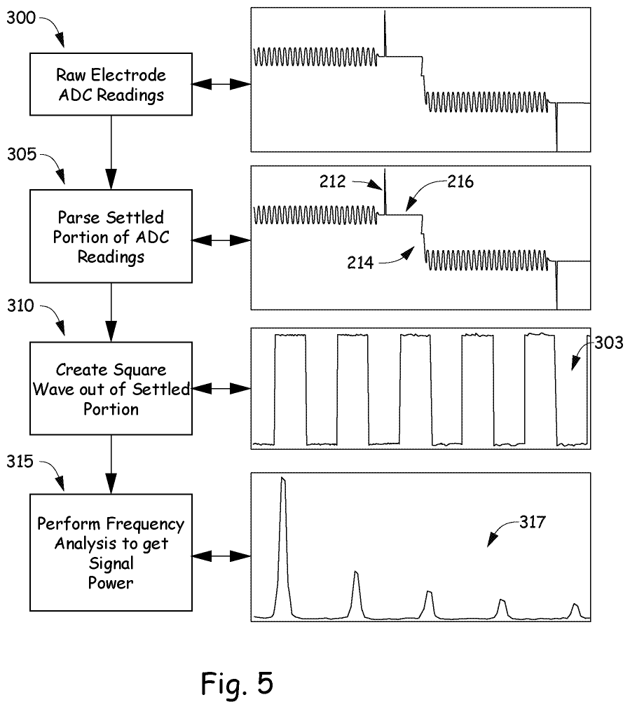

FIG. 5 is a flow diagram of the signal power calculation process in a particular embodiment of a magnetic flowmeter. To calculate the signal power value, at 300 the measurement circuitry of the flowmeter first takes the raw electrode ADC readings which measures full electrode ADC waveforms. These ADC readings are similar to the noisy electrode readings shown in graph 205 of FIG. 3B. At 305, the diagnostic module 170 parses the settled portion 216 of the ADC readings comprising the second time period to form a clean noise-free sample. As discussed with FIG. 3B, the last portion of each half wave is left untouched by noise and is used for flow calculations by the diagnostic module. As shown in this example, the settled portion resides between the injected noise 212 and the coil switching transient 214. The diagnostic module 170 calculates where these noise-free samples reside in the waveform and parses out the settled portion.

At 310, the diagnostic module creates an artificial square wave 303 out of the settled portion. In one embodiment, to obtain the best resolution from the signal processing calculation, the measurement circuitry collects data for a time period before the diagnostic module 170 performs each calculation and creates the artificial square wave out of the noise-free samples. For example, the measurement circuitry may collect data for a time period of two seconds to improve the resolution, but embodiments of the present disclosure need not be so limited. At 315, the diagnostic module 170 performs a frequency analysis on the square wave 303 to extract the signal power magnitude 317. In one example, the measurement circuitry may collect data for two seconds before performing each calculation to improve the resolution. Once the diagnostic module 170 has collected two seconds of raw electrode samples, it can parse the clean noise-free samples in the settled portion, create the artificial square wave based on the settled portion, and then perform a Fourier Transform to extract a clean signal power magnitude.

In one embodiment, once the flowmeter 102 has obtained the signal power magnitude, the flowmeter may additionally convert this value to feet per second, which can be compared to the fluid flow as a secondary reference. This is advantageous in a troubleshooting scenario, as the user may be able to validate their flow readings by referencing the signal.

In various aspects, the invention includes a magnetic flow meter signal power measurement that uses the same electrode voltage values as the flow measurement. The signal power measurement is free of noise, such as coil transient and diagnostic noise, and can be used as a secondary flow reference value. Additionally, a magnetic flow meter of the present embodiment uses true signal power values for its calculation of signal-to-noise ratios (SNRs) and can use the clean SNRs to guide the user on the best coil drive frequency to use.

With the present invention, a spectral content analysis on a captured diagnostic signal can be used to determine where in the frequency domain the lowest noise energy is located. In one example, a Goertzel algorithm may be used for the spectral analysis. This information can then be used to alert the user and present the user with an option to adjust the coil drive frequency to achieve a higher SNR and better flow stability. With this configuration, the process noise levels in terms of flow (or flow stability) can be determined. This information can also be used to adjust the coil drive frequency without user interaction. For example, if the system detects high process noise at the low coil drive frequency, and it is determines that the high coil drive frequency has a higher SNR, the system can automatically change the coil drive frequency to the high coil drive frequency. The system can be configured to utilize additional parallel FFT objects to provide a faster update rate. Further, the use of settled portion of the signal can be used for additional noise diagnostics.

Although the present invention has been described with reference to preferred embodiments, workers skilled in the art will recognize that changes may be made in form and detail without departing from the spirit and scope of the invention.

What is claimed is:

1. A magnetic flowmeter for measuring a flow rate of a fluid flow, comprising:
a flow tube assembly including a pipe section configured to receive the fluid flow, and a coil configured to receive a coil drive signal and produce a magnetic field across the fluid flow that induces an electromotive force (EMF) in the fluid flow that is proportional to the flow rate;
electrode sensors arranged to sense the EMF and generate electrode voltage values providing a sensor signal indicative of the flow rate;
measurement circuitry configured to sample a waveform of the magnetic field using the electrode voltage values of the sensor signal, wherein the sensor signal has a first time period and a second time period;
a noise diagnostic module configured to perform a diagnostic and parse the first time period and the second time period, wherein the first time period includes noise in the sensor signal and the second time period is indicative of a settled portion of the sensor signal.

2. The magnetic flow meter of claim 1, wherein the noise diagnostic module detects electrical noise near the electrode sensors caused by the fluid flow and spike noise caused by particle collision with the electrode sensors.

3. The magnetic flow meter of claim 1, wherein the sampled waveform in the first time period includes coil switching transient noise in the sensor signal from the reversal of the magnetic field every half coil cycle of the applied coil drive signal.

4. The magnetic flow meter of claim 1, wherein sampled waveform in the first time period includes injected diagnostic noise every half coil cycle.

5. The magnetic flow meter of claim 1, wherein the noise diagnostic module parses the waveform for the settled portion of the second time period that is noise-free.

6. The magnetic flow meter of claim 5, wherein the noise diagnostic module creates an artificial square wave based on the settled portion that is noise-free.

7. The magnetic flow meter of claim 6, wherein the noise diagnostic module performs a frequency analysis based on the artificial square wave to provide a noise-free signal power magnitude.

8. The magnetic flow meter of claim 7, wherein the noise diagnostic module provides a frequency signal-to-noise ratio (SNR) for a high coil drive frequency and low coil drive frequency based on the signal power magnitude.

9. The magnetic flow meter of claim 8, wherein an alert is activated if the SNR goes below a threshold.

10. The magnetic flow meter of claim 8, wherein a preferred coil drive frequency may be chosen based on the highest SNR.

11. The magnetic flow meter of claim 7, wherein the measurement circuitry collects data for a time period for use in each calculation of the signal power magnitude.

12. The magnetic flow meter of claim 7, wherein a Fourier Transform is used to extract the signal power magnitude.

13. The magnetic flow meter of claim 7, wherein the signal power magnitude is converted to feet per second.

14. The magnetic flow meter of claim 13, wherein the converted signal power magnitude is compared to the flow rate as a secondary reference.

15. The magnetic flow meter of claim 14, wherein the flow readings are validated by referencing the signal power.

16. A method comprising:
receiving a fluid flow through a pipe section of a flow tube assembly;
producing a magnetic field across the fluid flow with a coil that induces an electromotive force (EMF) in the fluid flow that is proportional to the flow rate;
generating electrode voltage values from electrode sensors arranged to sense the EMF that is indicative of the flow rate;
measuring an electrode waveform using the electrode voltage values indicative of the flow rate;
calculating noise-free samples within the measured waveform with a noise diagnostic module;
creating an artificial square wave out of the noise-free samples;
extracting a clean signal power magnitude from the square wave.

17. The method of claim 16, wherein the signal power magnitude is converted to feet per second and compared to the fluid flow as a secondary reference.

18. The method of claim 16, further comprising calculating a frequency signal-to-noise ratio (SNR) for a high frequency coil drive signal and low frequency coil drive signal based on the signal power magnitude.

19. The method of claim 18, wherein the SNR is calculated by dividing the signal power magnitude by a noise magnitude of the signal.

20. The method of claim 18, wherein the SNR may be improved by selecting the best coil drive frequency based on the calculated SNRs.
